(19) United States
(12) Patent Application Publication
(10) Pub. No.: US 2015/0143406 A1
(43) Pub. Date: May 21, 2015

(54) BROADCAST RECEIVING APPARATUS AND METHOD FOR DISPLAYING NOTIFICATION MESSAGE USING THE SAME

(71) Applicant: SAMSUNG ELECTRONICS CO., LTD., Suwon-si (KR)

(72) Inventors: Young-hoon CHO, Suwon-si (KR); Tae-hoon KIM, Suwon-si (KR); Tae-hyeun HA, Suwon-si (KR)

(73) Assignee: SAMSUNG ELECTRONICS CO., LTD., Suwon-si (KR)

(21) Appl. No.: 14/492,747

(22) Filed: Sep. 22, 2014

(30) Foreign Application Priority Data
Nov. 15, 2013 (KR) 10-2013-0139364

(51) Int. Cl. H04N 21/436; H04N 21/81; H04N 21/431; H04N 21/435; H04N 21/41

(52) U.S. Cl. CPC H04N 21/43615; H04N 21/435; H04N 21/4131; H04N 21/431; H04N 21/8126
USPC 725/32

(57) ABSTRACT

A broadcast receiving apparatus including a display, a storage configured to store priority information corresponding to a current output state of the broadcast receiving apparatus and priority information corresponding to an event, a communicator configured to receive, from an external device, a signal indicating an occurrence of the event at the external device, and a controller configured to, upon the communicator receiving the signal indicating the occurrence of the event at the external device, selectively display a notification message regarding the event on the display, based on the priority information corresponding to the event and the priority information corresponding to the current output state of the broadcast receiving apparatus.

### CROSS-REFERENCE TO RELATED APPLICATION

This application claims priority from Korean Patent Application No. 10-2013-0139364, filed on Nov. 15, 2013, in the Korean Intellectual Property Office, the disclosure of which is incorporated herein by reference in its entirety.

### BACKGROUND

1. Field

Apparatuses and methods consistent with exemplary embodiments relate to a broadcast receiving apparatus and a method for displaying a notification message using the same, and more particularly, to a broadcast receiving apparatus which is a part of a network system, and a method for displaying a notification message using the same.

2. Description of the Related Art

In general, a home network system is a network system in which diverse devices inside and outside a home are integrated by diverse cable or wireless technologies. Thanks to home network systems, users can efficiently use diverse devices.

However, users may be uncomfortable because related-art home network systems indiscriminately notify users of events occurring at devices.

For example, while watching television content, a user may be notified of washing completion of a washer against his or her will, and thus may be distracted.

Accordingly, there is a need for a home network system capable of minimizing interruptions for users while watching content.

### SUMMARY

Exemplary embodiments may overcome the above disadvantages and other disadvantages not described above. Also, exemplary embodiments are not required to overcome the disadvantages described above, and an exemplary embodiment may not overcome any of the problems described above.

An exemplary embodiment may provide a broadcast receiving apparatus capable of selectively displaying an event occurring at a device included in a network system according to a priority, and a method for displaying a notification message using the same.

According to an aspect of an exemplary embodiment, there is provided a broadcast receiving apparatus that includes a display, a storage configured to store priority information corresponding to a current output state of the broadcast receiving apparatus and priority information corresponding to an event, a communicator configured to receive, from an external device, a signal indicating an occurrence of the event at the external device, and a controller configured to, upon the communicator receiving the signal indicating the occurrence of the event at the external device, selectively display a notification message regarding the event on the display, based on the priority information corresponding to the event and the priority information corresponding to the current output state of the broadcast receiving apparatus.

The controller, in response to the priority information corresponding to the event indicating that a priority of the event is higher than or equal to a priority of the current output state of the broadcast receiving apparatus indicated by the priority information corresponding to the current output state of the broadcast receiving apparatus, may display the notification message on the display.

The controller, in response to the priority information corresponding to the event indicating that a priority of the event is lower than a priority of the current output state of the broadcast receiving apparatus indicated by the priority information corresponding to the current output state of the broadcast receiving apparatus, may store information regarding the event but not display the notification message on the display.

The controller, in response to the output state of the broadcast receiving apparatus changing after the controller stores the information regarding the event, may selectively display the notification message regarding the event based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

The controller may overlay the notification message regarding the event on a currently displayed screen.

The controller may remove the currently displayed screen and displays the notification message regarding the event in place of the currently displayed screen.

The priority information corresponding to the event may include a priority of the event that is set by a user and the priority information corresponding to the current output state of the broadcast receiving apparatus may include a priority of the current output state of the broadcast receiving apparatus that is set by the user.

According to an aspect of another exemplary embodiment, there is provided a method for displaying a notification message at a broadcast receiving apparatus that includes receiving, from an external device, a signal indicating an occurrence of an event at the external device, and upon receiving the signal indicating the occurrence of the event at the external device, selectively displaying a notification message regarding the event on a display, based on priority information corresponding to the event and priority information corresponding to a current output state of the broadcast receiving apparatus.

In response to the priority information corresponding to the event indicating that a priority of the event is higher than or equal to a priority of the current output state of the broadcast receiving apparatus indicated by the priority information corresponding to the current output state of the broadcast receiving apparatus, the notification message may be displayed.

In response to the priority information corresponding to the event indicating that a priority of the event is lower than a priority of the current output state of the broadcast receiving apparatus indicated by the priority information corresponding to the current output state of the broadcast receiving apparatus, information regarding the event may be stored but the notification message may not be displayed on the display.

In response to the output state of the broadcast receiving apparatus changing after storing the information regarding the event, the notification message regarding the event may be selectively displayed based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

In the displaying operation, the notification message regarding the event may be overlaid on a currently displayed screen.

In the displaying operation, the currently displayed screen may be removed and the notification message regarding the event may be displayed in place of the currently displayed screen.

The priority information corresponding to the event may include a priority of the event that is set by a user and the priority information corresponding to the current output state of the broadcast receiving apparatus may include a priority of the current output state of the broadcast receiving apparatus that is set by the user.

According to an aspect of another exemplary embodiment, there is provided a non-transitory computer readable medium storing a program causing a computer to execute a method for displaying a notification message at a broadcast receiving apparatus that includes receiving, from an external device, a signal indicating an occurrence of an event at the external device, and upon receiving the signal indicating the occurrence of the event at the external device, selectively displaying a notification message regarding the event on a display, based on priority information corresponding to the event and priority information corresponding to a current output state of the broadcast receiving apparatus.

In response to the priority information corresponding to the event indicating that a priority of the event is higher than or equal to a priority of the current output state of the broadcast receiving apparatus indicated by the priority information corresponding to the current output state of the broadcast receiving apparatus, the notification message may be displayed.

In response to the priority information corresponding to the event indicating that a priority of the event is lower than a priority of the current output state of the broadcast receiving apparatus indicated by the priority information corresponding to the current output state of the broadcast receiving apparatus, information regarding the event may be stored but the notification message may not be displayed on the display.

In response to the output state of the broadcast receiving apparatus changing after storing the information regarding the event, the notification message regarding the event may be selectively displayed based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

In the displaying operation, the notification message regarding the event may be overlaid on a currently displayed screen.

In the displaying operation, the currently displayed screen may be removed and the notification message regarding the event may be displayed in place of the currently displayed screen.

The priority information corresponding to the event may include a priority of the event that is set by a user and the priority information corresponding to the current output state of the broadcast receiving apparatus may include a priority of the current output state of the broadcast receiving apparatus that is set by the user.

According to an aspect of another exemplary embodiment, there is provided a broadcast receiving apparatus that includes a display, a storage configured to store priority information corresponding to each of a plurality of output states of the broadcast receiving apparatus and priority information corresponding to each of a plurality of events, a communicator configured to receive, from an external device, a signal indicating an event occurring at the external device, and a controller configured to, upon the communicator receiving the signal indicating the event occurring at the external device, determine a priority of a current output state of the broadcast receiving apparatus and determine a priority of the event indicated by the signal received by the communicator, using the priority information corresponding to each of the plurality of output states of the broadcast receiving apparatus and the priority information corresponding to each of the plurality of events stored in the storage and selectively display a notification message regarding the event on the display, based on the determined priority of the current output state of the broadcast receiving apparatus and the determined priority of the event.

The controller, in response to determining that the priority of the event is higher than or equal to the priority of the current output state of the broadcast receiving apparatus, may be configured to display the notification message on the display.

The controller, in response to determining that the priority of the event is lower than the priority of the current output state of the broadcast receiving apparatus, may be configured to store information regarding the event but not display the notification message on the display.

The controller, in response to the output state of the broadcast receiving apparatus changing after the controller stores the information regarding the event, may be configured to selectively display the notification message regarding the event based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

The controller may overlay the notification message regarding the event on a currently displayed screen.

The controller may remove the currently displayed screen and display the notification message regarding the event in place of the currently displayed screen.

The priority of the event and the priority of the current output state of the broadcast receiving apparatus may be set by a user.

According to an aspect of another exemplary embodiment, there is provided a method for displaying a notification message at a broadcast receiving apparatus that includes receiving, from an external device, a signal indicating an event occurring at the external device, and upon receiving the signal indicating the event occurring at the external device, determining a priority of a current output state of the broadcast receiving apparatus and determining a priority of the event indicated by the received signal, using stored priority information corresponding to each of a plurality of output states of the broadcast receiving apparatus and stored priority information corresponding to each of a plurality of events and selectively displaying a notification message regarding the event on a display, based on the determined priority of the current output state of the broadcast receiving apparatus and the determined priority of the event.

In response to determining that the priority of the event is higher than or equal to the priority of the current output state of the broadcast receiving apparatus, the notification message may be displayed.

In response to determining that the priority of the event is lower than the priority of the current output state of the broadcast receiving apparatus, information regarding the event may be stored without displaying the notification message.

In response to the output state of the broadcast receiving apparatus changing after storing the information regarding the event, the notification message regarding the event may be selectively displayed based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

In the displaying operation, the notification message regarding the event may be overlaid on a currently displayed screen.

In the displaying operation, the currently displayed screen may be removed and the notification message regarding the event displayed in place of the currently displayed screen

The priority of the event and the priority of the current output state of the broadcast receiving apparatus may be set by a user.

According to an aspect of another exemplary embodiment, there is provided a non-transitory computer readable medium storing a program causing a computer to execute a method for displaying a notification message at a broadcast receiving apparatus that includes receiving, from an external device, a signal indicating an event occurring at the external device, and upon receiving the signal indicating the event occurring at the external device, determining a priority of a current output state of the broadcast receiving apparatus and determining a priority of the event indicated by the received signal, using stored priority information corresponding to each of a plurality of output states of the broadcast receiving apparatus and stored priority information corresponding to each of a plurality of events and selectively displaying a notification message regarding the event on a display, based on the determined priority of the current output state of the broadcast receiving apparatus and the determined priority of the event.

In response to determining that the priority of the event is higher than or equal to the priority of the current output state of the broadcast receiving apparatus, the notification message may be displayed.

In response to determining that the priority of the event is lower than the priority of the current output state of the broadcast receiving apparatus, information regarding the event may be stored without displaying the notification message.

In response to the output state of the broadcast receiving apparatus changing after storing the information regarding the event, the notification message regarding the event may be selectively displayed based on the priority of the event and a priority of the changed output state of the broadcast receiving apparatus.

The output state of the broadcast receiving apparatus may include at least one of a broadcast content output state, an advertisement output state, a menu setting state, a channel changing state, and an input signal changing state.

In the displaying operation, the notification message regarding the event may be overlaid on a currently displayed screen.

In the displaying operation, the currently displayed screen may be removed and the notification message regarding the event displayed in place of the currently displayed screen

The priority of the event and the priority of the current output state of the broadcast receiving apparatus may be set by a user.

According to the exemplary embodiments, an event occurring in a network system may be selectively displayed according to priority. Therefore, interruptions for the user while watching content may be minimized, and the user may be effectively notified of an event occurring in the network system.

Additional and/or other aspects and advantages will be set forth in part in the description which follows and, in part, will be obvious from the description, or may be learned by practice of the exemplary embodiments.

### BRIEF DESCRIPTION OF THE DRAWING FIGURES

The above and/or other aspects will be more apparent by describing certain exemplary embodiments with reference to the accompanying drawings, in which:

FIG. 1 illustrates a network system according to an exemplary embodiment;

FIG. 2 is a block diagram illustrating a configuration of a network apparatus according to an exemplary embodiment;

FIGS. 3A, 3B, 3C, 4, 5A, 5B, 5C, 6A, 6B, and 7 illustrate displayed forms of a notification message and a method for setting a notification message according to exemplary embodiments;

FIG. 8 illustrates a method for selectively displaying a notification message according to an exemplary embodiment;

FIG. 9 is a detailed block diagram illustrating a configuration of a broadcast receiving apparatus according to an exemplary embodiment; and

FIG. 10 is a flowchart illustrating a method for displaying a notification message at a broadcast receiving apparatus according to an exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

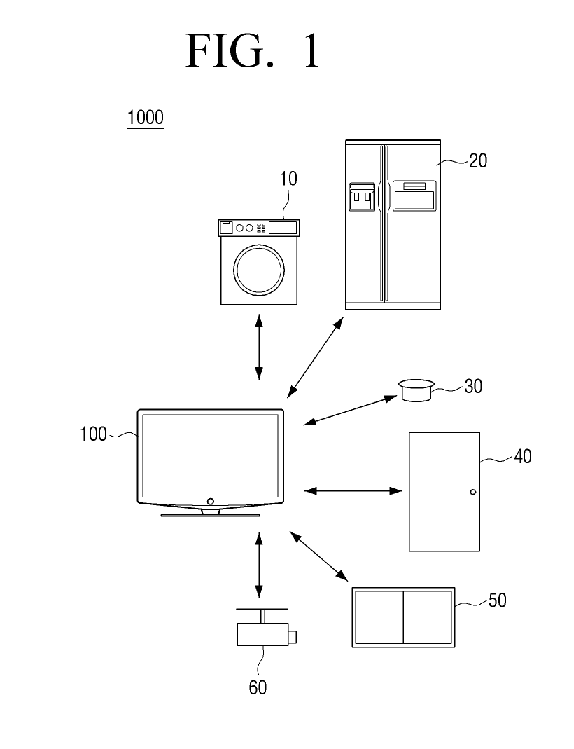

FIG. 1 illustrates a network system according to an exemplary embodiment. As shown in FIG. 1, the network system 1000 may include a broadcast receiving apparatus 100 and a plurality of devices 10, 20, 30, 40, 50, and 60.

The network system 1000 may be implemented as a home network system in which all of the electrical devices and electronic devices used at home are connected by cable or wirelessly and thus are capable of two-way communication. However, this is merely an example. Any system in which a plurality of devices are connected and controlled over a network may function as the network system 1000. For example, a system in which devices in a company are connected and controlled over a network may function as the network system 1000.

The broadcast receiving apparatus 100 is a part of the network system 1000, and is used for control of the overall network system, that is, central control. In other words, the broadcast receiving apparatus 100 is a device included in the network system 1000, and also controls operation of other devices in the network system 1000.

In this case, the broadcast receiving apparatus 100 may be implemented with a television (TV) which acts as a home server as shown in FIG. 1, but this is merely an example. Other devices included in the network system 1000 or a separate device such as a home server, a home controller, or a home gateway may be used for central control.

More specifically, the broadcast receiving apparatus 100 may control the plurality of devices 10, 20, 30, 40, 50, and 60 which form the network system 1000 according to a user command.

In other words, the broadcast receiving apparatus 100 may store control commands to control diverse functions provided by the plurality of devices 10, 20, 30, 40, 50, and 60, and transmit to the plurality of devices 10, 20, 30, 40, 50, and a control command corresponding to a received user command among the pre-stored control commands. For example, when the network apparatus 100 receives a user command to unlock the door 40, the network apparatus 100 may transmit to the door 40 a control command to unlock the door 40 among the pre-stored control commands.

In this case, the user command may be received from a device included in the network system 1000. In other words, the broadcast receiving apparatus 100 may control the plurality of devices 10, 20, 30, 40, 50, and 60 which form the network system 1000 according to a user command which is input through the broadcast receiving apparatus 100 or a user command which is received from one or more of the plurality of devices 10, 20, 30, 40, 50, and 60.

To do so, the broadcast receiving apparatus 100 and the plurality of devices 10, 20, 30, 40, 50, and 60 may display a user interface (UI) for receiving a user command. Items which compose the UI may vary according to the type of the device included in the network system 1000 or an executable function of each device.

In addition, the broadcast receiving apparatus 100 may control operation of other devices based on an event occurring at one or more of the plurality of devices 10, 20, 30, 40, 50, and 60. The event may include operation completion of a device, a problem of a device, fire detected by a device, and an invasion of a stranger. To do so, when an event occurs, one or more of the plurality of devices 10, 20, 30, 40, 50, and 60 may transmit a signal indicating the event to the broadcast receiving apparatus 100.

For example, when the washer 10 finishes an operation such as washing or drying, the washer 10 may transmit a signal indicating completion of the operation to the broadcast receiving apparatus 100, or when the refrigerator 20 has a problem, the refrigerator 20 may transmit a signal indicating the existence of the problem to the broadcast receiving apparatus 100.

In addition, when the fire detector 30 detects fire, the fire detector 30 may transmit a signal indicating fire detection to the broadcast receiving apparatus 100, or when the door 40, the window 50, or the security camera 60 detects an invasion of a stranger, the door 40, the window 50, or the security camera 60 may transmit a signal indicating the invasion of the stranger to the broadcast receiving apparatus 100.

In this case, which event is indicated by a signal received from one or more of the plurality of devices 10, 20, 30, 40, 50, and 60 may be predetermined between the broadcast receiving apparatus 100 and the plurality of devices 10, 20, 30, 40, 50, and 60. Accordingly, the broadcast receiving apparatus 100 may determine which event occurs based on the signal received from one or more of the plurality of devices 10, 20, 30, 40, 50, and 60.

In addition, the broadcast receiving apparatus 100 may control operation of other devices based on a signal received from each device 10, 20, 30, 40, 50, and 60.

More specifically, the broadcast receiving apparatus 100 may control a device included in the network system 1000 to display a notification message to notify the user of the occurrence of an event.

In this case, when the broadcast receiving apparatus 100 is a TV having a display function as in FIG. 1, the broadcast receiving apparatus 100 may autonomously display the notification message. However, in some cases, the broadcast receiving apparatus 100 may transmit a control command, to a device having a display function, that instructions the device to display the notification message.

At this time, the broadcast receiving apparatus 100 may selectively display the notification message regarding the event. In other words, the broadcast receiving apparatus 100 may selectively display the notification message regarding the event based on a priority of an output state of the broadcast receiving apparatus 100 and a priority of the event. More detailed description is provided below with reference to the attached drawings.

In FIG. 1, the network system 1000 includes the TV 100, the washer 10, the refrigerator 20, the fire detector 30, the door 40, the window 50, and the security camera 60, but this is merely an example. The number and type of the devices which form the network system 1000 may change in diverse ways.

The broadcast receiving apparatus 100 and the plurality of devices 10, 20, 30, 40, 50, and 60 may form the network system 1000 by being connected to one another using one or more diverse communication methods. For example, the broadcast receiving apparatus 100 may form the network system 1000 together with the plurality of devices 10, 20, 30, 40, 50, and 60 in a universal plug and play (UPnP) protocol using a cable/wireless local area network (LAN), a wide area network (WAN), Ethernet, Bluetooth, Zigbee, universal serial bus (USB), institute of electrical and electronics engineers (IEEE) 1394, wireless fidelity (WiFi), power line communication (PLC) or the like.

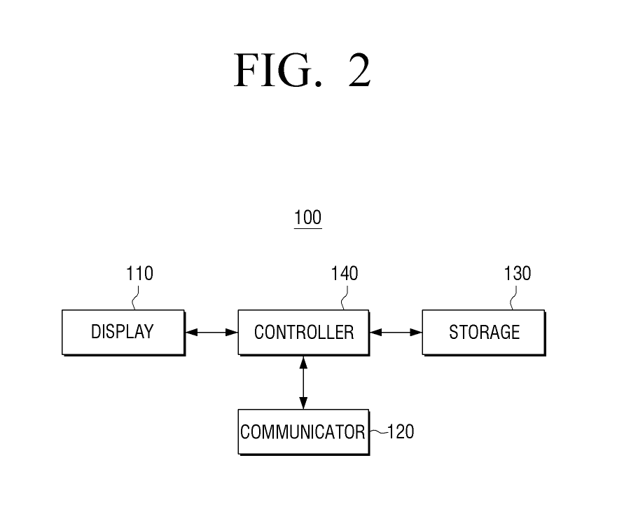

FIG. 2 is a block diagram illustrating a configuration of a network apparatus according to an exemplary embodiment. With reference to FIG. 2, the broadcast receiving apparatus 100 may include a display 110, a communicator 120, a storage 130, and a controller 140.

The display 110 displays diverse screens. More specifically, the display 110 may display diverse contents which are externally received or are stored in the broadcast receiving apparatus 100.

In addition, the display 110 may display a notification message regarding an event. In this case, the notification message may be provided in a graphical user interface (GUI) form, and a more detailed description will be provided later.

The display 110 may be implemented with a liquid crystal display (LCD), an organic light emitting display (OLED), a plasma display panel (PDP), or the like.

The communicator 120 communicates with an external device. For example, the communicator 120 may communicate with at least one device included in the network system 1000 of FIG. 1 based on a UPnP protocol. To do so, the communicator 120 may include diverse communication modules (not shown) which are accessible to the network.

The communicator 120 may receive a signal indicating an event occurring at an external device. In other words, the communicator 120 may receive a signal indicating an event occurring at least one device included in the network system 1000 from the device, and when the event occurs, the external device may transmit the signal indicating the occurring of the event to the broadcast receiving apparatus 100.

The storage 130 stores priority information regarding a current output state of the broadcast receiving apparatus 100, and priority information regarding an external event.

The current output state may include at least one of a broadcast content output state, an advertisement output state, a menu setting state, a channel changing state, and an input signal changing state. More specifically, the storage 130 may store information regarding a priority set for each of the broadcast content output state, the advertisement output state, the menu setting state, the channel changing state, and the input signal changing state, and an example is shown below in Table 1.

TABLE 1

| Priority | Output state |
|---|---|
| 1 | Broadcast content output |
| 2 | Advertisement output |
| 3 | Menu setting |
| 4 | Channel changing/input signal changing |

In priorities of the current output states shown in Table 1, a state in which the broadcast receiving apparatus 100 displays broadcast content is 1^{st} priority, a state in which the broadcast receiving apparatus 100 displays an advertisement is 2^{nd} priority, a state in which the broadcast receiving apparatus 100 displays a menu screen (for example, a menu screen to set options related to the broadcast receiving apparatus 100) is 3^{rd} priority, and a state in which the broadcast receiving apparatus 100 changes the channel or changes to an external input signal is 4^{th} priority.

The event is an event occurring at least one device included in the network system 1000, and may include an invasion of a stranger detected by a device, an outbreak of fire, a problem of a device, and operation completion of a device. More specifically, the storage 130 may store information regarding a priority set for each of an invasion of a stranger, an outbreak of fire, a problem of a device, and operation completion of a device, and an example is shown below in Table 2.

TABLE 2

| Priority | Event |
|---|---|
| 0 | Invasion of a stranger |
| 1 | Fire |
| 2 | Trouble |
| 3 | Operation completion |

In priorities of the events shown in Table 2, an invasion of a stranger is 0^{th} priority, an outbreak of fire is 1^{st} priority, a problem of a device is 2^{nd} priority, and operation completion of a device is 3^{rd} priority.

To do so, the storage 130 may include diverse types of storage media (not shown). For example, the storage 130 may include at least one storage medium of a flash memory type, a hard disk type, a multimedia card micro type, and a memory card type (for example, an SD or XD memory), a random-access memory (RAM), and a read-only memory (ROM).

The controller 140 controls overall operation of the broadcast receiving apparatus 100. The controller 140 may include a microcomputer (or a microcomputer and a central processing unit (CPU)), and a RAM and a ROM to operate the broadcast receiving apparatus 100.

More specifically, when a signal indicating an event occurring at an external device is received, the controller 140 may selectively display a notification message regarding the event on the display 110 based on a priority of the event and a priority of a current output state of the broadcast receiving apparatus 100.

In other words, when a signal indicating an event occurring at an external device is received, the controller 140 determines which event occurs at the external device. In this case, which event the signal received from at least one device included in the network system 1000 indicates may be predetermined between the broadcast receiving apparatus 100 and the plurality of devices 10, 20, 30, 40, 50, and 60.

Subsequently, the controller 140 determines a priority of the determined event. In this case, the controller 140 may use priority information regarding the events pre-stored in the storage 130. For example, when priorities of events are as shown in Table 2, the controller 140 may determine that when the event occurring at the external device is an invasion of a stranger, a priority of the event is the 0^{th} priority, or that when the event occurring at the external device is operation completion, priority of the event is the 3^{rd} priority.

In addition, the controller 140 determines priority of a current output state. In this case, the controller 140 may use priority information regarding current output states pre-stored in the storage 130. For example, when priorities of current output states are as shown in Table 1, the controller 140 may determine that when broadcast content is currently displayed, a priority of the current output state is the 1^{st} priority.

Subsequently, the controller 140 may selectively display a notification message regarding the event based on the priority of the current output state of the broadcast receiving apparatus 100 and the priority of the event.

More specifically, when the priority of the event is higher than or equal to the priority of the current output state of the broadcast receiving apparatus 100, the controller 140 may display a notification message. In this case, the notification message is a message to notify the user of the occurrence of the event. The notification message may be implemented with a different text or image according to the event.

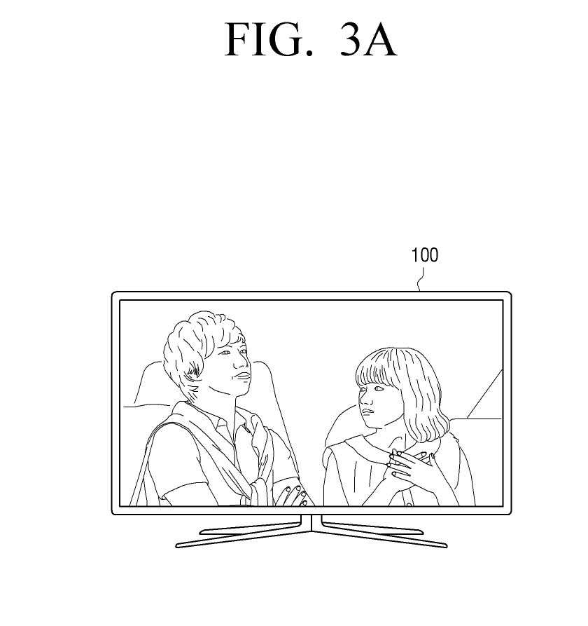

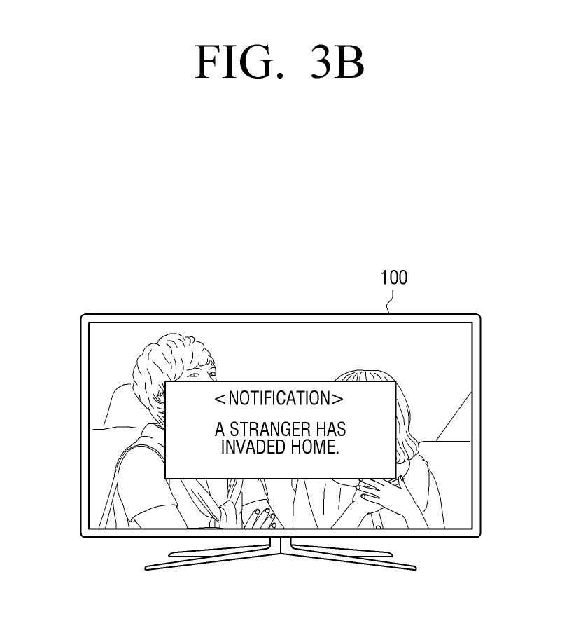

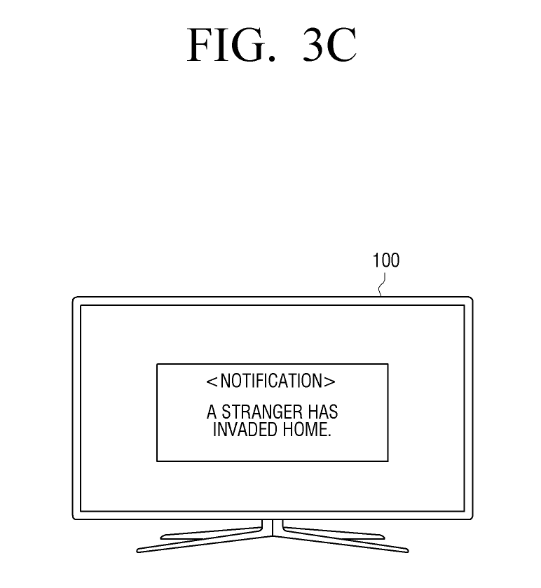

For example, when the broadcast receiving apparatus 100 displays broadcast content as shown in FIG. 3A and when an event of an invasion of a stranger occurs, the controller 140 may determine that a priority regarding the invasion of the stranger is higher than priority regarding the state in which the broadcast content is displayed, and may display a notification message, “a stranger has invaded home,” to notify the user of the invasion of the stranger.

In this case, the controller 140 may display the notification message using one or more diverse methods. More specifically, the controller 140 may overlay the event notification message on a currently displayed screen, or may remove the currently displayed screen and display the event notification message in place of the currently displayed screen.

For example, the controller 140 may overlay and display a notification message, “a stranger has invaded home,” on currently displayed broadcast content as shown in FIG. 3B, or may stop displaying the currently displayed broadcast content and display the notification message, “a stranger has invaded home,” in place of the currently displayed broadcast content as shown in FIG. 3C. A displayed format of the notification message may be set or changed by the user.

A notification message may be displayed for a predetermined period of time. In other words, when a notification message overlaps on a currently displayed screen and is displayed, the controller 140 may display the notification message for a predetermined period of time and then remove the notification message, or when only a notification message is displayed, the controller 140 may display the notification message for a predetermined period of time, remove the notification message, and display a previously displayed screen.

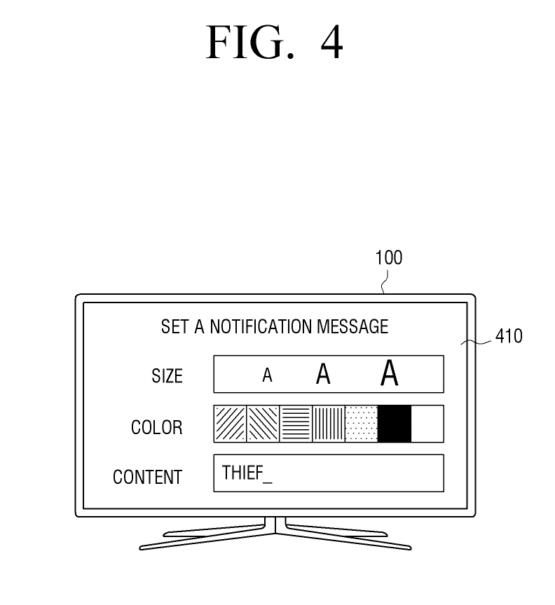

In addition, text or an image which composes a notification message may be pre-stored in the broadcast receiving apparatus 100 in manufacture, or may be set or changed by the user. For example, the controller 140 may enable the user to directly input size, color, and content of text which composes a notification message through a menu screen 410 to set the notification message as shown in FIG. 4, and may store the notification message set by the user for each event and display the notification message when an event occurs in the future.

In addition, a notification message may be provided in a GUI format such as text or an image, or in an audio format.

In this case, the controller 140 may output a notification message in an audio format together with audio which is currently output by the broadcast receiving apparatus 100, or may mute the currently output audio and only output the notification message in the audio format.

On the other hand, when the priority of the event is lower than the priority of the current output state of the broadcast receiving apparatus 100, the controller 140 may not display a notification message but store information regarding the event.

In other words, when the priority of the event is lower than the priority of the current output state of the broadcast receiving apparatus 100, the controller 140 may not display a notification message but maintain the current output state and store priority information regarding the event occurring at the external device.

For example, when the broadcast receiving apparatus 100 displays broadcast content and when an event of operation completion of the washer 10 occurs, the controller 140 may determine that priority regarding the operation completion of the washer 10 is lower than priority regarding the state in which the broadcast content is displayed, and may not display a notification message regarding the operation completion of the washer 10 but continue to display the broadcast content and store the 3^{rd} priority as a priority regarding the operation completion of the washer 10.

In this case, the controller 140 may arrange and store a priority of each device according to priority. More specifically, when storing priority information regarding each event occurring at the plurality of devices 10, 20, 30, 40, 50, and 60, the controller 140 may sort and store the priority information according to priority.

When the current output state of the broadcast receiving apparatus 100 changes after the priority information regarding the event is stored, the controller 140 may selectively display a notification message regarding the event based on the priority of the event and the priority of the changed output state of the broadcast receiving apparatus 100.

More specifically, when the current output state of the broadcast receiving apparatus 100 changes, the controller 140 determines a priority of the changed output state. In this case, the controller 140 may use the priority information regarding the current output states pre-stored in the storage 130.

For example, when priorities of output states are as shown in Table 1 and when an output state changes from displaying broadcast content to displaying an advertisement, the controller 140 may determine that priority of a current output state is the 2^{nd} priority, or when an output state changes from displaying broadcast content to changing a channel, the controller 140 may determine that priority of a current output state is the 4^{th} priority

Subsequently, the controller 140 may compare the priority of the changed output state and the stored priority of the event, and selectively display a notification message regarding the event.

In this case, when the stored priority of the event is higher than the priority of the changed output state of the broadcast receiving apparatus 100, the controller 140 may display a notification message.

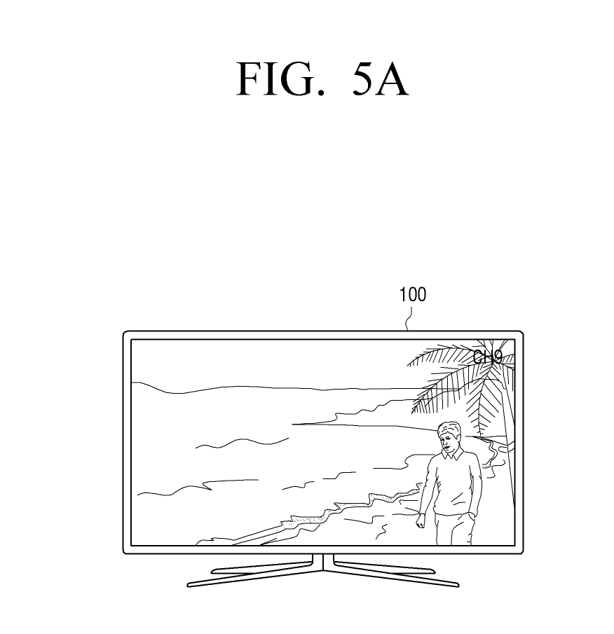

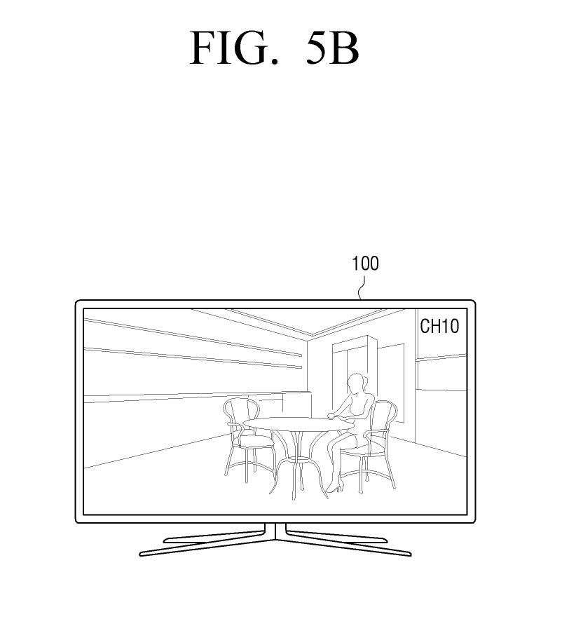

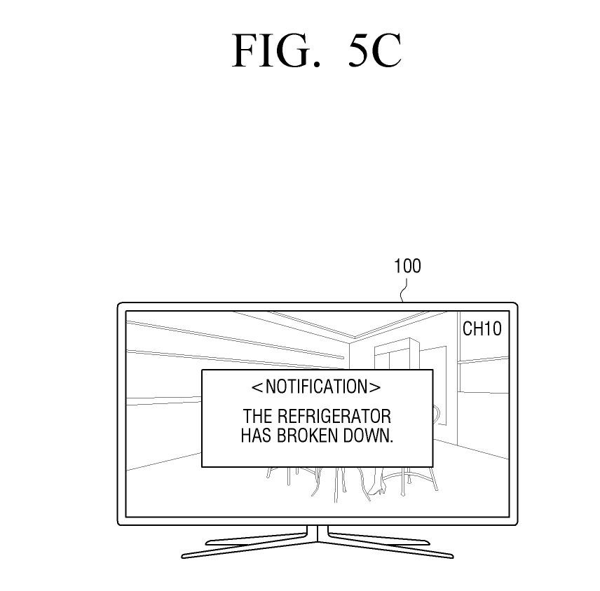

For example, assume a case in which a priority regarding a problem of the refrigerator 20 is stored, and the output state of the broadcast receiving apparatus 100 changes from displaying broadcast content to changing a channel as shown in FIGS. 5A and 5B. In this case, since the stored priority regarding the problem of the device is higher than the priority regarding a state of changing the channel, the controller 140 may display a notification message indicating the problem of the refrigerator 20 as shown in FIG. 5C.

Subsequently, the controller 140 may reset (or remove) the stored priority information regarding the event since the user has been notified of the occurrence of the event related to the stored priority information by the notification message.

On the other hand, when the stored priority of the event is lower than the priority of the changed output state of the broadcast receiving apparatus 100, the controller 140 may not display a notification message but maintain the changed output state.

For example, assume a case in which a priority regarding a problem of the refrigerator 20 is stored, and the output state of the broadcast receiving apparatus 100 changes from displaying broadcast content to displaying an advertisement. In this case, since the stored priority regarding the problem of the device is lower than a priority regarding the state of displaying the advertisement, the controller 140 may not display a notification message but continue displaying the advertisement.

In this case, the controller 140 does not reset the stored priority information regarding the event until the stored priority of the event becomes higher than or equal to a priority of a changed output state. A notification message is displayed when a priority of an event is higher than or equal to a priority of a current output state of the broadcast receiving apparatus 100. Accordingly, the priority information regarding the previously occurring event is continuously stored until the controller 140 notifies the user of the event occurring at the external device using a notification message, that is, until the stored priority of the event becomes higher than a priority of a changed output state.

When a priority of an event is equal to a priority of a current output state of the broadcast receiving apparatus 100, the controller 140 may deal with the situation in the same manner as when a priority of an event is higher than a priority of a current output state of the broadcast receiving apparatus 100.

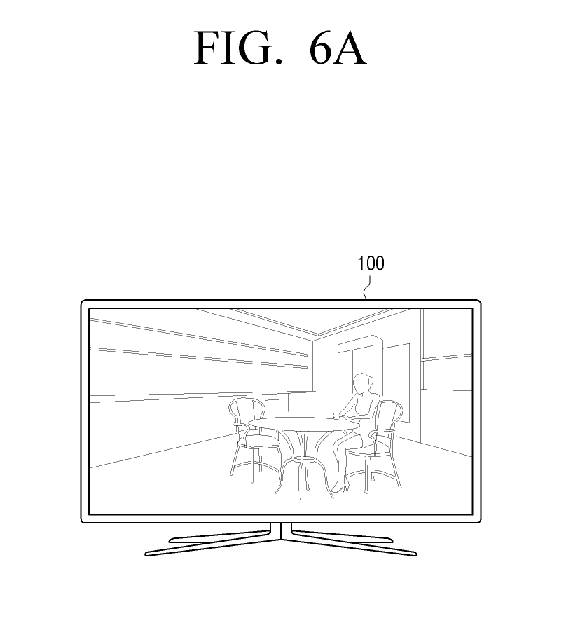

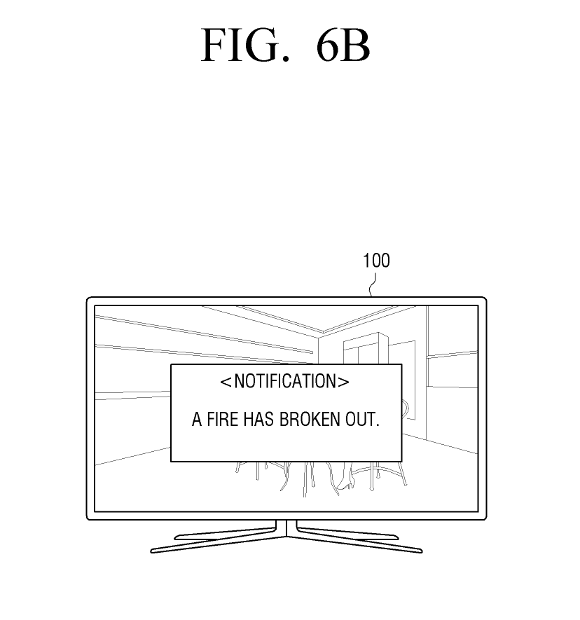

For example, when the broadcast receiving apparatus 100 displays broadcast content as shown in FIG. 6A and when an event of outbreak of fire occurs, the controller 140 may determine that both a priority of the current output state of the broadcast receiving apparatus 100 and a priority of the event are 1^{st} priority, and may display a notification message, “fire has broken out,” as shown in FIG. 6B.

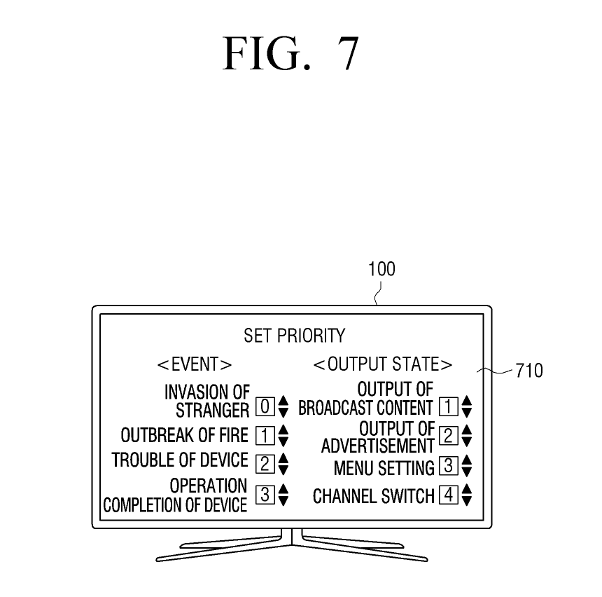

Priorities of events and priorities of current output states of the broadcast receiving apparatus 100 may be set in manufacture or may be set or changed by the user. For example, the controller 140 may enable the user to directly input priorities of events and priorities of current output states of the broadcast receiving apparatus 100 using a menu screen 710 to set priorities as shown in FIG. 7, and may store the priorities set by the user and selectively display a notification message based on the set priorities when an event occurs in the future.

According to an exemplary embodiment, the broadcast receiving apparatus 100 may selectively display an event occurring in the network system 1000 according to a priority. Therefore, interruptions for the user while watching content may be minimized, and the user may be effectively notified of an event occurring in the network system 1000.

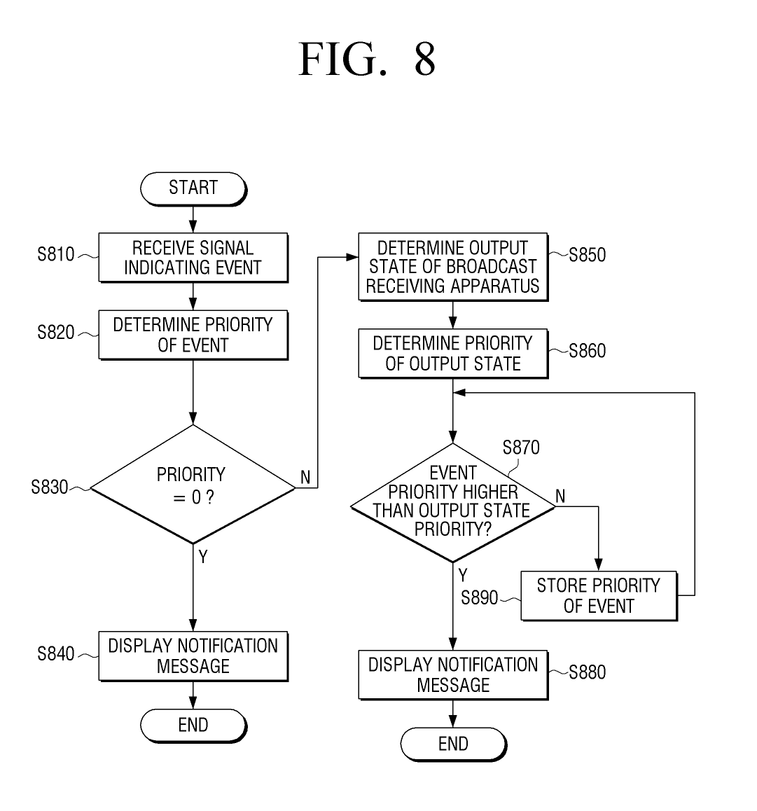

In the above examples, a notification message regarding an event is selectively displayed by comparing a priority of the event and a priority of a current output state of the broadcast receiving apparatus 100, but this is merely an example. The controller 140 may display a notification message regarding an event without comparing priorities when a predetermined condition is satisfied. This is described in greater detail with reference to FIG. 8.

FIG. 8 illustrates a method for selectively displaying a notification message according to an exemplary embodiment. Detailed description of an overlapping portion between FIG. 8 and FIGS. 1 to 7 is not repeated.

Firstly, when a signal indicating an event is received from an external device (S810), the controller 140 determines a priority of the event (S820). In this case, the controller 140 may use priority information regarding events defined as in Table 2.

Subsequently, the controller 140 determines whether the priority of the event corresponds to a predetermined priority (S830). The predetermined priority is a higher priority, for example 0^{th} priority in Tables 1 and 2, than the top priority among priorities of current output states of the broadcast receiving apparatus 100 pre-stored in the storage 130. That is, the controller 140 determines whether the priority of the event is 0^{th} priority.

When it is determined that the priority of the event corresponds to the predetermined priority (S830—Y), the controller 140 may display a notification message regarding the event (S840). For example, when it is determined that the event is invasion of a stranger and priority of the event is 0^{th} priority, the controller 140 may display a notification message to notify the user of invasion of the stranger regardless of the current output state of the broadcast receiving apparatus 100.

When the priority of the event corresponds to the predetermined priority as described above, the controller 140 may display a notification message regarding the event without comparing the priority of the event and priority of a current output state of the broadcast receiving apparatus 100.

When it is determined that the priority of the event does not correspond to the predetermined priority (S830—N), the controller 140 determines the current output state of the broadcast receiving apparatus 100 (S850) and determines a priority of the determined current output state (S860). In this case, the controller 140 may use priority information regarding output states defined as in Table 1.

Subsequently, the controller 140 may selectively display a notification message based on the priority of the event and the priority of the current output state of the broadcast receiving apparatus 100.

More specifically, the controller 140 determines whether the priority of the event is higher than or equal to the priority of the current output state of the broadcast receiving apparatus 100 (S870).

When the priority of the event is higher than or equal to the priority of the current output state of the broadcast receiving apparatus 100 (S870—Y), the controller 140 displays a notification message regarding the event (S880). However, when the priority of the event is lower than the priority of the current output state of the broadcast receiving apparatus 100 (S870—N), the controller 140 does not display a notification message but maintains the current output state and stores priority information regarding the event (S890).

In the above exemplary embodiments, the broadcast receiving apparatus 100 performs central control in the network system 1000. However, even when another device (referred to hereinafter as a control device) is used for central control, the broadcast receiving apparatus 100 may selectively display a notification message.

In this case, the control device may receive a signal indicating an event from one or more of the other devices included in the network system 1000, and transmit the signal to the broadcast receiving apparatus 100. The broadcast receiving apparatus 100 may determine a priority of the event using the received signal, and selectively display a notification message regarding the event based on the priority of the event and a priority of a current output state of the broadcast receiving apparatus 100.

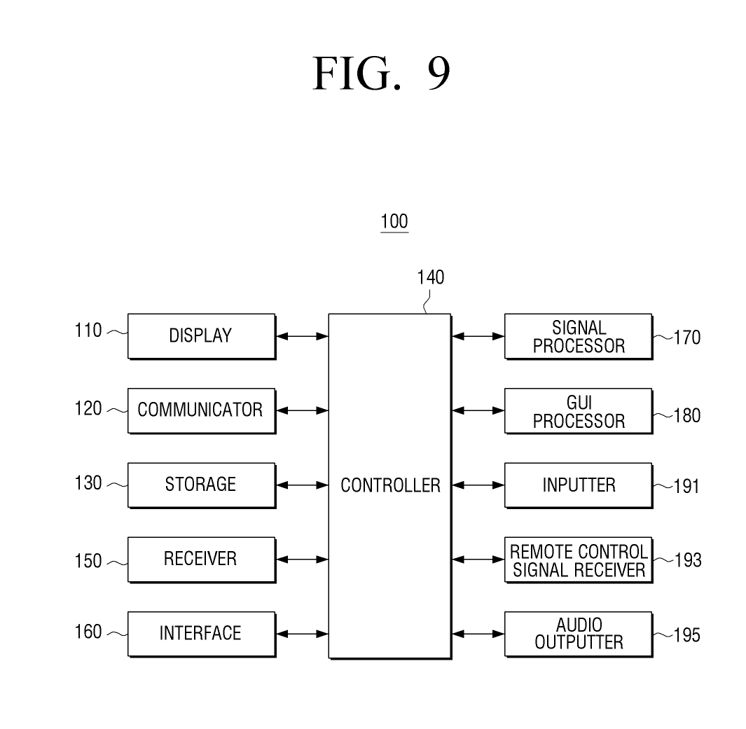

FIG. 9 is a detailed block diagram illustrating a configuration of the broadcast receiving apparatus 100 according to an exemplary embodiment. With reference to FIG. 9, the broadcast receiving apparatus 100 may further include a receiver 150, an interface 160, a signal processor 170, a GUI processor 180, an inputter 191, a remote control signal receiver 193, and an audio outputter 195 as well as the display 110, the communicator 120, the storage 130, and the controller 140. Operation of these components may be controlled by the controller 140. Detailed description of an overlapping portion between the components shown in FIG. 9 and the components shown in FIG. 2 is not repeated.

The receiver 150 may receive diverse contents. More specifically, the receiver 150 may receive broadcast content from broadcasting stations which use a broadcast network such as terrestrial broadcasting, cable broadcasting, and satellite broadcasting. To do so, the receiver 150 may include a tuner (not shown), a demodulator (not shown), and an equalizer (not shown).

In addition, the receiver 150 may receive content from a web server which transmits content over the internet. To do so, the receiver 150 may include a network interface card (not shown).

The interface 160 may be connected to diverse types of recording medium playback devices to receive content stored in a recording medium. The recording medium playback device is a device which plays back content stored in diverse types of recording media such as a compact disk (CD), a digital versatile disk (DVD), a hard disk, a Blu-ray disk, a memory card, and a USB memory. In this case, the interface 160 may be implemented with diverse types of ports such as a high definition multimedia interface (HDMI) and a USB port.

The signal processor 170 processes content provided through the receiver 150 or the interface 160. More specifically, the signal processor 170 may process an image included in the content into a format which can be output by the display 110 by performing decoding, scaling, frame rate conversion, and the like. In addition, the signal processor 170 may process audio included in the content into a format which can be output by the audio outputter 193 by performing decoding and the like.

Accordingly, the display 110 may display the image included in the content, and the audio outputter 193 may output the audio included in the content.

The GUI processor 180 generates a GUI to display on the display 110. More specifically, the GUI processor 180 may generate a notification message regarding an event in a GUI form. The GUI may be added to an image included in content and be displayed with the image, or only the GUI may be displayed.

The inputter 191 receives diverse user commands. More specifically, the inputter 191 may receive a user command such as power on or off, channel changing, volume adjustment, changing to an external input signal, and diverse menu settings, and transmit the user command to the controller 140.

In this case, the controller 140 may control other components to perform an operation corresponding to the user command. For example, when a user command to change the channel is input, the controller 140 may control the receiver 150 to be tuned into a channel selected by the user and receive broadcast content, or when a user command to change to an external input signal is input, the controller 140 may control the interface 160 to receive content from an external source selected by the user.

The inputter 191 may be implemented as an input panel. For example, the input panel may include a touch pad, a keypad including diverse function keys, number keys, special keys, and character keys, and a touch screen.

The remote control signal receiver 193 receives a remote control signal input from a remote control (not shown). For example, the remote control signal receiver 193 may receive remote control signals corresponding to diverse user commands to control operation of the broadcast receiving apparatus 100, such as power on or off, channel changing, volume adjustment, changing to an external input signal, and diverse menu settings. In this case, the controller 140 may perform an operation corresponding to a received remote control signal.

The audio outputter 195 outputs audio. More specifically, the audio outputter 195 may output audio included in content, and a notification message which is formed in an audio format. To do so, the audio outputter 195 may include a speaker, an audio output port, and so on.

The controller 140 may determine a current output state of the broadcast receiving apparatus 100 using diverse methods. For example, the controller 140 may determine whether broadcast content or an advertisement is displayed using electronic program guide (EPG) information or an identifier included in a broadcast signal. In addition, the controller 140 may determine whether a channel is changed based on whether a user command to change the channel is input, and the controller 140 may determine whether a change to an external input signal is performed based on whether a user command to change to the external input signal is input.

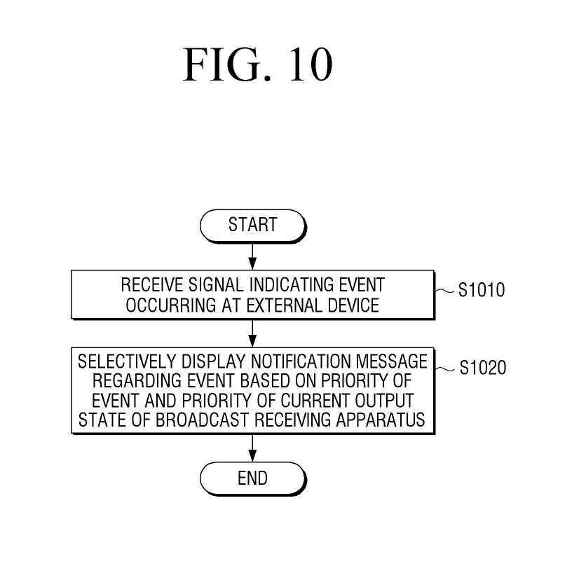

FIG. 10 is a flowchart illustrating a method for displaying a notification message at the broadcast receiving apparatus 100 according to an exemplary embodiment.

Firstly, the broadcast receiving apparatus 100 receives a signal indicating an event occurring at an external device (S1010).

Subsequently, the broadcast receiving apparatus 100 selectively displays a notification message regarding the event based on a priority of the event and a priority of a current output state of the broadcast receiving apparatus 100 (S1020).

More specifically, when the priority of the event is higher than or equal to the priority of the current output state of the broadcast receiving apparatus 100, the broadcast receiving apparatus 100 may display a notification message.

However, when the priority of the event is lower than the priority of the current output state of the broadcast receiving apparatus 100, the broadcast receiving apparatus 100 may not display a notification message but store information regarding the event.

When the output state of the broadcast receiving apparatus 100 changes after storing information regarding the event, the broadcast receiving apparatus 100 may selectively displays a notification message regarding the event based on the priority of the event and a priority of a changed output state of the broadcast receiving apparatus 100.

Output states of the broadcast receiving apparatus 100 may include at least one of a broadcast content output state, an advertisement output state, a menu setting state, a channel changing state, and an input signal changing state.

In operation S1020, the notification message may be displayed in diverse forms. More specifically, the broadcast receiving apparatus 100 may overlay the notification message on the currently displayed screen, or may remove the currently displayed screen and display only the notification message.

Priorities of events or priorities of current output states of the broadcast receiving apparatus 100 may be set by the user. For example, a menu screen to set priorities is displayed as shown in FIG. 7 so that the user may set priorities on the menu screen.

According to the exemplary embodiments, the user may be notified of the occurrence of an event selectively according to priority. Therefore, interruptions for the user while watching content may be minimized, and the user may be effectively notified of an event occurring in the network system 1000.

A program which sequentially performs a method for displaying a notification message according to the exemplary embodiments may be stored in a non-transitory computer readable medium.

For example, a program which performs a method including receiving a signal indicating an event occurring at an external device, and selectively displaying a notification message regarding the event based on a priority of the event and a priority of a current output state of the broadcast receiving apparatus 100 may be stored in a non-transitory computer readable medium.

The non-transitory computer readable medium may be a medium which does not store data temporarily such as a register, cache, and memory but stores data semi-permanently and is readable by electronic devices. More specifically, the aforementioned applications or programs may be stored in the non-transitory computer readable medium such as compact disks (CDs), digital video disks (DVDs), hard disks, Blu-ray disks, universal serial buses (USBs), memory cards, and read-only memory (ROM).

In the block diagrams of the broadcast receiving apparatus 100, a bus is not shown, but communication among the components may be performed by a bus. In addition, a network device and a user terminal device may further include a processor, such as a CPU and a micro processor, capable of performing the aforementioned operations.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A broadcast receiving apparatus comprising:
a display;
a storage configured to store priority information corresponding to a current output state of the broadcast receiving apparatus and priority information corresponding to an event;
a communicator configured to receive, from an external device, a signal indicating an occurrence of the event at the external device; and
a controller configured to, in response to the communicator receiving the signal indicating the occurrence of the event at the external device, selectively display a notification message regarding the event on the display, based on the priority information corresponding to the event and the priority information corresponding to the current output state of the broadcast receiving apparatus.

2. The broadcast receiving apparatus as claimed in claim 1, wherein the controller, in response to the priority information corresponding to the event indicating that a priority of the event is higher than or equal to a priority of the current output state of the broadcast receiving apparatus indicated by the priority information corresponding to the current output state of the broadcast receiving apparatus, is configured to display the notification message on the display.

3. The broadcast receiving apparatus as claimed in claim 1, wherein the controller, in response to the priority information corresponding to the event indicating that a priority of the event is lower than a priority of the current output state of the broadcast receiving apparatus indicated by the priority information corresponding to the current output state of the broadcast receiving apparatus, is configured to store information regarding the event but not display the notification message on the display.

4. The broadcast receiving apparatus as claimed in claim 3, wherein the controller, in response to the output state of the broadcast receiving apparatus changing after the controller stores the information regarding the event, is configured to selectively display the notification message regarding the event based on the priority of the event and a priority of the changed output state of the broadcast receiving apparatus.

5. The broadcast receiving apparatus as claimed in claim 1, wherein the output state of the broadcast receiving apparatus comprises at least one of a broadcast content output state, an advertisement output state, a menu setting state, a channel changing state, and an input signal changing state.

6. The broadcast receiving apparatus as claimed in claim 1, wherein the controller overlays the notification message regarding the event on a currently displayed screen.

7. The broadcast receiving apparatus as claimed in claim 1, wherein the controller is configured to remove the currently displayed screen and displays the notification message regarding the event in place of the currently displayed screen.

8. The broadcast receiving apparatus as claimed in claim 1, wherein the priority information corresponding to the event comprises a priority of the event that is set by a user and the priority information corresponding to the current output state of the broadcast receiving apparatus comprises a priority of the current output state of the broadcast receiving apparatus that is set by the user.

9. A method for displaying a notification message at a broadcast receiving apparatus, the method comprising:
receiving, from an external device, a signal indicating an occurrence of an event at the external device; and
in response to the receiving the signal indicating the occurrence of the event at the external device, selectively displaying a notification message regarding the event on a display, based on priority information corresponding to the event and priority information corresponding to a current output state of the broadcast receiving apparatus.

10. The method as claimed in claim 9, wherein in response to the priority information corresponding to the event indicating that a priority of the event is higher than or equal to a priority of the current output state of the broadcast receiving apparatus indicated by the priority information corresponding to the current output state of the broadcast receiving apparatus, the notification message is displayed.

11. The method as claimed in claim 9, further comprising:
in response to the priority information corresponding to the event indicating that a priority of the event is lower than a priority of the current output state of the broadcast receiving apparatus indicated by the priority information corresponding to the current output state of the broadcast receiving apparatus, storing information regarding the event but not displaying the notification message on the display.

12. The method as claimed in claim 11, wherein in response to the output state of the broadcast receiving apparatus changing after storing the information regarding the event, the notification message regarding the event is selectively displayed based on the priority of the event and a priority of the changed output state of the broadcast receiving apparatus.

13. The method as claimed in claim 9, wherein the output state of the broadcast receiving apparatus comprises at least one of a broadcast content output state, an advertisement output state, a menu setting state, a channel changing state, and an input signal changing state.

14. The method as claimed in claim 9, wherein in the displaying the notification message, the notification message regarding the event is overlaid on a currently displayed screen.

15. The method as claimed in claim 9, wherein in the displaying, the currently displayed screen is removed and the notification message regarding the event is displayed in place of the currently displayed screen.

16. The method as claimed in claim 9, wherein the priority information corresponding to the event comprises a priority of the event that is set by a user and the priority information corresponding to the current output state of the broadcast receiving apparatus comprises a priority of the current output state of the broadcast receiving apparatus that is set by the user.

17. A broadcast receiving apparatus comprising:
a display;
a storage configured to store priority information corresponding to each of a plurality of output states of the broadcast receiving apparatus and priority information corresponding to each of a plurality of events;
a communicator configured to receive, from an external device, a signal indicating an event occurring at the external device; and
a controller configured to, in response to the communicator receiving the signal indicating the event occurring at the external device, (i) determine a priority of a current output state of the broadcast receiving apparatus and determine a priority of the event indicated by the signal received by the communicator, using the priority information corresponding to each of the plurality of output states of the broadcast receiving apparatus and the priority information corresponding to each of the plurality of events stored in the storage and (ii) selectively display a notification message regarding the event on the display, based on the determined priority of the current output state of the broadcast receiving apparatus and the determined priority of the event.

18. The broadcast receiving apparatus as claimed in claim 17, wherein the controller, in response to determining that the priority of the event is higher than or equal to the priority of the current output state of the broadcast receiving apparatus, is configured to display the notification message on the display.

19. The broadcast receiving apparatus as claimed in claim 17, wherein the controller, in response to determining that the priority of the event is lower than the priority of the current output state of the broadcast receiving apparatus, is configured to store information regarding the event but not display the notification message on the display.

20. The broadcast receiving apparatus as claimed in claim 19, wherein the controller, in response to the output state of the broadcast receiving apparatus changing after the controller stores the information regarding the event, is configured to selectively display the notification message regarding the event based on the priority of the event and a priority of the changed output state of the broadcast receiving apparatus.

21. A method for displaying a notification message at a broadcast receiving apparatus, the method comprising:
receiving, from an external device, a signal indicating an event occurring at the external device; and
in response to receiving the signal indicating the event occurring at the external device, (i) determining a priority of a current output state of the broadcast receiving apparatus and determining a priority of the event indicated by the received signal, using stored priority information corresponding to each of a plurality of output states of the broadcast receiving apparatus and stored priority information corresponding to each of a plurality of events and (ii) selectively displaying a notification message regarding the event on a display, based on the determined priority of the current output state of the broadcast receiving apparatus and the determined priority of the event.

22. The method as claimed in claim 21, wherein in response to determining that the priority of the event is higher than or equal to the priority of the current output state of the broadcast receiving apparatus, the notification message is displayed.

23. The method as claimed in claim 21, further comprising:
in response to determining that the priority of the event is lower than the priority of the current output state of the broadcast receiving apparatus, storing information regarding the event without displaying the notification message.

24. The method as claimed in claim 23, wherein in response to the output state of the broadcast receiving apparatus changing after storing the information regarding the event, the notification message regarding the event is selectively displayed based on the priority of the event and a priority of the changed output state of the broadcast receiving apparatus.

25. The method as claimed in claim 21, wherein the output state of the broadcast receiving apparatus comprises at least one of a broadcast content output state, an advertisement output state, a menu setting state, a channel changing state, and an input signal changing state.

26. The method as claimed in claim 21, wherein in the displaying, the notification message regarding the event is overlaid on a currently displayed screen.
